(19) United States
(12) Patent Application Publication
(10) Pub. No.: US 2018/0027854 A1
(43) Pub. Date: Feb. 1, 2018

(54) Shelf Stable Hummus Food Product and Mix Kit

(71) Applicants: Alon Kruvi, Scarsdale, NY (US); Rakesh Barmecha, Scarsdale, NY (US)

(72) Inventors: Alon Kruvi, Scarsdale, NY (US); Rakesh Barmecha, Scarsdale, NY (US)

(21) Appl. No.: 15/221,323

(22) Filed: Jul. 27, 2016

(51) Int. Cl. A23L 25/00

(52) U.S. Cl. CPC A23L 25/30; A23V 2002/00

(57) ABSTRACT

A shelf stable hummus food product having three ingredients; chickpeas, tahini, and spices. To keep the hummus mixture shelf stable for a longer period, it is best to isolate the Chickpeas from tahini and spices until it is ready for consumption. The three ingredients are provided in their own separate packages or bags. When required to make one, the consumer has to: rip open each packet; empty the contents completely into a container; and stir all ingredients together thoroughly until smooth. During this stirring or mixing process, the tahini mixes with the water from the chickpea puree and before the bacteria activity begins and disintegration starts, the citric acid: a) helps combining the ingredients forming a homogenous creamy and smooth paste; b) acts as an emulsifying agent to keep the tahini, water and chickpea from separating.

### SEQUENCE LISTING OR PROGRAM

Not Applicable

### FEDERALLY SPONSORED RESEARCH

Not Applicable

### CROSS REFERENCE TO RELATED APPLICATIONS

Not Applicable

### TECHNICAL FIELD OF THE PRESENT INVENTION

The present invention relates generally to a shelf stable food products and mix kits. More specifically the present invention relates to hummus food products and mix kits that provide for the food product to be stored in a non-refrigerated environment without the addition of preservatives for up to 18 months.

### BACKGROUND OF THE PRESENT INVENTION

Food products and mix kits of various types which require a minimum amount of purchaser preparation are common items in grocery store refrigerator and freezer sections. Examples include pizzas, pancakes, desserts and frozen dinners. Such products are typically purchased by consumers who do not want to spend a lot of time preparing foods to eat. Consumers, however, expect an easy way to prepare food products to be fresh in appearance and texture and, most importantly, to taste good.

Hummus is a Levantine and Egyptian food dip or spread made from cooked, mashed chickpeas or other beans, blended with tahini, olive oil, lemon juice, salt and garlic. Today, it is popular throughout the Middle East, North Africa), and in Middle Eastern cuisine around the globe. It can be found in most grocery stores in North America.

Hummus' popularity has actually been a few years in the making, with Americans gravitating toward it for a few reasons. In 2006, hummus was present in 12 percent of American households, rising to 17 percent by early 2009. In 2008, more than 15 million Americans consumed hummus on a regular basis, becoming a popular staple in American restaurants. As the trend for healthy eating continues unabated, hummus is a nutritious, light alternative compared to other spreads or dips.

Authentic hummus is supposed to be: freshly made, served at room temperature, and be preservative free. In order to increase shelf lives of hummus, manufacturers have to add preservatives and stabilizers that allow the hummus to last longer—but in a refrigerator. The added preservatives and stabilizers also make the hummus a little grainy because of the added chemicals. The preservatives and stabilizers take away the real taste and make the hummus “heavier” to consume, in direct contrast to what many believe has led to its rising popularity.

Therefore, what is needed is a method of packaging and selling a hummus kit or mixture that has an increased shelf life without the use of preservatives and stabilizers and/or refrigeration.

### SUMMARY OF THE PRESENT INVENTION

The major ingredient of hummus is chickpeas. To retain the maximum nutrients, the chickpeas have to be soaked overnight. For a creamy and smooth hummus, the skins of the cooked chickpeas have to be removed as much as possible and that has to be done by soaking them overnight and cooking them with a little baking soda. If not, the hummus may turn very grainy & thick.

When the chickpea puree is mixed with tahini, the tahini will react with the water in the chickpea puree and form bacteria in the mixture if not refrigerated or preserved with chemicals. When the chickpea puree is mixed with spices, the citric acid (form of citrus/lemon) will thicken up or coagulate the puree and make it lumpy which is not how hummus should be prepared or served.

To keep the hummus mixture shelf stable for a longer period, it is best to isolate the Chickpeas from tahini and spices until it is ready for consumption. The present invention teaches a shelf stable hummus food product comprising three ingredients; chickpeas, tahini, and spices. The three ingredients are provided in their own separate packages or bags.

When required to make one, the consumer has to: rip open each packet; empty the contents completely into a container; and stir all ingredients together thoroughly until smooth. During this stirring or mixing process, the tahini mixes with the water from the chickpea puree and before the bacteria activity begins and disintegration starts, the citric acid: a) helps combining the ingredients forming a homogenous creamy and smooth paste; and b) acts as an emulsifying agent to keep the tahini, water and chickpea from separating.

### BRIEF DESCRIPTION OF THE DRAWINGS

With respect to the present invention, no drawings are necessary for the understanding of the subject matter sought to be patented under 35 USC 113. When the nature of such subject matter admits of illustration by a drawing and the applicant has not furnished such a drawing, the Director may require its submission within a time period of not less than two months from the sending of a notice thereof.

FIG. 1 is a table showing lab results of bacteria growth in tahini.

FIG. 2 is a table showing the lab results of bacteria growth in a tahini spice mixture.

FIG. 3 is a table showing the lab results of yeast growth in a tahini spice mixture.

FIG. 4 is a representation of the three package shelf stable hummus food product and mix kit.

### DETAILED DESCRIPTION OF THE PRESENT INVENTION

In the following detailed description of the present invention a plurality of exemplary embodiments of the present invention are taught. These embodiments are described in sufficient detail to enable those skilled in the art to practice the present invention, but other embodiments may be utilized and logical, mechanical, electrical, chemical, and other changes may be made without departing from the scope of the present invention. The following detailed description is therefore, not to be taken in a limiting sense, and the scope of the present invention is defined only by the appended claims.

In the following description, numerous specific details are set forth to provide a thorough understanding of the present invention. However, it is understood that the present invention may be practiced without these specific details. In other instances, well-known structures and techniques known to one of ordinary skill in the art have not been shown in detail in order not to obscure the present invention.

Authentic hummus is supposed to be: freshly made, served at room temperature, and be preservative free. In order to increase shelf lives of hummus, manufacturers have to add preservatives and stabilizers that allow the hummus to last longer—but in a refrigerator. The added preservatives and stabilizers also make the hummus a little grainy because of the added chemicals. The preservatives and stabilizers take away the real taste and make the hummus “heavier” to consume, in direct contrast to what many believe has led to its rising popularity.

Hummus, in its basic form, is a food dip or spread made from three basic components: 1) chickpeas, 2) tahini (ground sesame seeds), and 3) spices. Typically hummus is made from cooked, mashed chickpeas or other beans, blended with tahini, olive oil, lemon juice, salt and garlic.

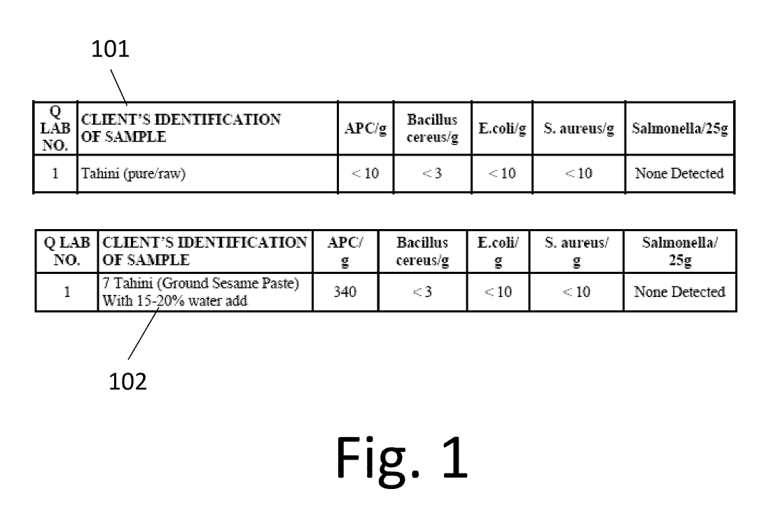

When tahini is in its pure, raw state it starts to form bacteria slowly as shown in the results 101 of FIG. 1. When it is mixed with water, as in a hummus mixture, bacteria forms rapidly as shown by the results 102 of FIG. 1 and the tahini must be consumed immediately or refrigerated to slow the bacteria growth and consumed within a day or two. Alternatively, preservatives can be added to increase shelf life both with and without refrigeration.

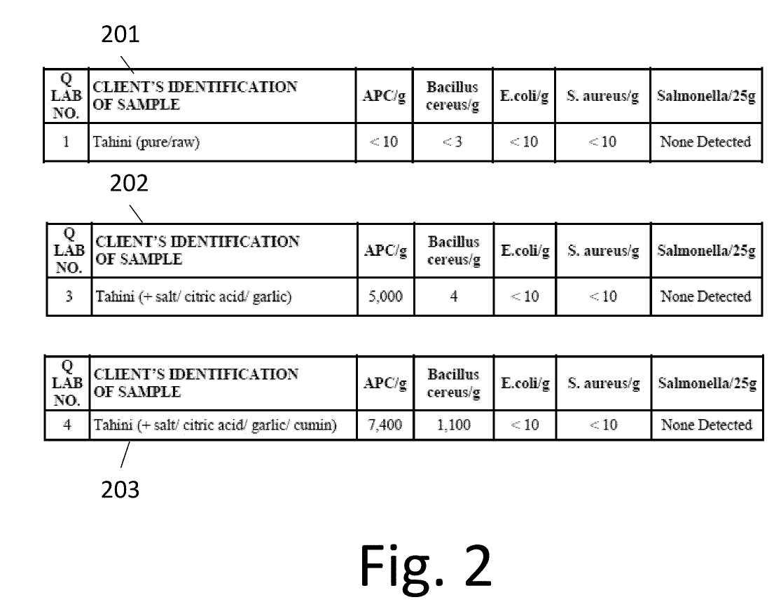

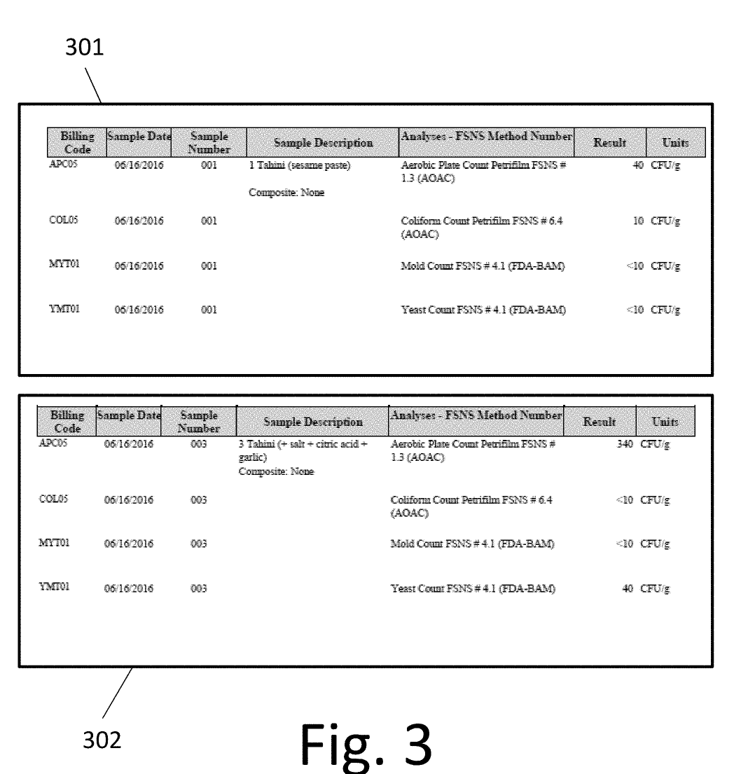

When the tahini is mixed with spices (such as lemon, salt, garlic, cumin, etc.), the tahini shows an increase in activity in Aerobic Plate Count per gram (APC/g) and Bacillus cereus/g counts as shown in the results 201 for pure/raw tahini, 202 for tahini with salt, citric acid, and garlic, and 203 for tahini with salt, citric acid, garlic, and cumin of FIG. 2 and yeast count as shown in the results 301 for pure/raw tahini, and 302 for tahini with salt, citric acid, and garlic of FIG. 3.

As previously discussed, authentic hummus is supposed to be: freshly made, served at room temperature, and be preservative free. In order to increase shelf lives of hummus, manufacturers have to add preservatives and stabilizers that allow the hummus to last longer—but in a refrigerator. The added preservatives and stabilizers also make the hummus a little grainy because of the added chemicals. The preservatives and stabilizers take away the real taste and make the hummus “heavier” to consume, in direct contrast to what many believe has led to its rising popularity.

The citric acid from the spice mixture coagulates the tahini and makes it very thick. To reach a thinner consistency, water has to be added, which can't be done as established during testing of tahini mixed with water as the food product then has no shelf life and must be immediately consumed or refrigerated and consumed in 1-2 days, an unrealistic time period for making, distributing, selling, and consuming a food product.

To keep the food product shelf stable for a longer period, it is best to isolate the Tahini from water and spices based on the experimentation results.

The major ingredient of hummus is chickpeas. To retain the maximum nutrients, the chickpeas have to be soaked overnight. This also makes them tender. For a creamy and smooth hummus, the skins of the cooked chickpeas have to be removed as much as possible and that has to be done by soaking them overnight and cooking them with a little baking soda. If not, the hummus may turn very grainy & thick.

When the chickpea puree is mixed with tahini, the tahini will react with the water in the chickpea puree and form bacteria in the mixture if not refrigerated or preserved with chemicals, as established during lab testing and experimentation shown in FIGS. 1 and 2.

When the chickpea puree is mixed with spices, the citric acid (form of citrus/lemon) will thicken up or coagulate the puree and make it lumpy which is not how hummus should be prepared or served. To keep the hummus mixture shelf stable for a longer period, it is best to isolate the Chickpeas from tahini and spices until it is ready for consumption.

The goal or purpose of the present invention is to make a hummus food product that is: Preservative free, Shelf stable, Fresh, Smooth/Creamy, and containing Fewer calories.

### Preparation of Chickpea Puree

For a creamy and smooth hummus, the skins of the cooked chickpeas have to be removed as much as possible and that has to be done by soaking them overnight and cooking them with a little baking soda. If not, the hummus may turn very grainy & thick. With added water the cooked chickpeas are then mashed to a smooth puree, filled in special laminated pouches and subject to retort process to sterilize the cooked chickpea puree from bacteria. Retorting the puree is a better alternative to canned chickpeas which contain salt and often have a distinct smell. With the retort process, the average shelf life of this puree becomes 18 months.

### Preparation of Tahini:

From the previous discussion, it has been determined that if/when spices are added, the mixture begins to grow bacteria and yeast. Therefore, it is best to store the tahini separately to maintain tahini's natural shelf life of 18 months or more.

### Preparation of Spices:

Spices are shelf stable products and do not require any preservatives for stability and have a typical shelf life of 18-24 months. The reason to store the spices separately has been established as above, where the citric acid coagulates the tahini and makes it very thick.

The inventor(s) have found that to have a self-stable hummus food product, the three main ingredients of chickpeas, tahini, and spices must be kept separate until consumption is desired. As there are only simple pure ingredients in the mixture taught by the present invention, the calorie count is maintained to the minimum in comparison to any other similar product with additional ingredients or which use preservatives and stabilizers to extend shelf life.

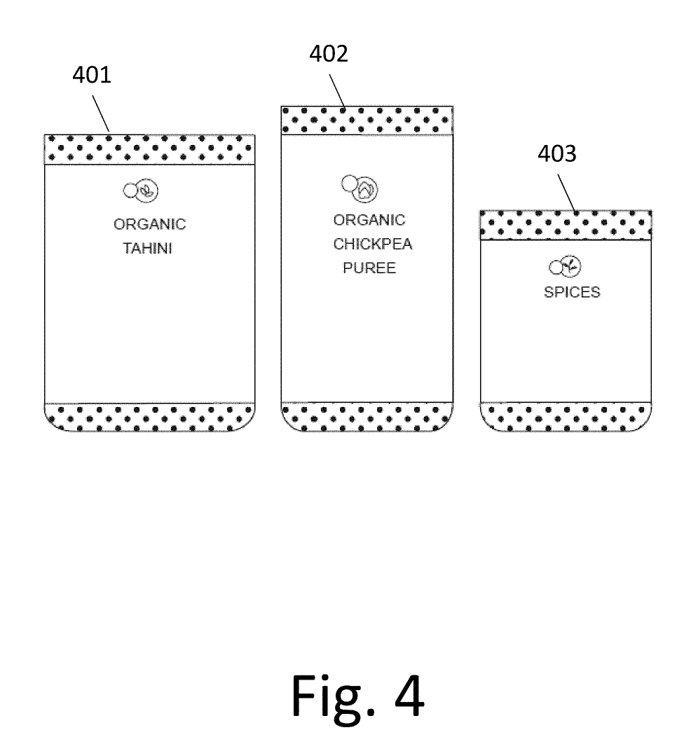

The present invention teaches a shelf stable hummus food product comprising three ingredients; chickpeas, tahini, and spices. The three ingredients are provided in their own separate packages or bags 401, 402, and 403 as shown in FIG. 4. When required to make the hummus, the consumer has to: rip open each packet; empty the contents completely into a container; and stir all ingredients together thoroughly until smooth.

Depending on the packaging, the three ingredients can be individually packaged or isolated in a container or other packaging that results in essentially individually wrapping or packing the ingredients by keeping them separate until desired for consumption.

In alternative embodiments all or part of the packaging may be used as a mixing bowl for mixing the three isolated ingredients together. The packaging may also include utensils for mixing in or as part of the packaging.

During this stirring or mixing process, the tahini mixes with the water from the chickpea puree and before the bacteria activity begins and disintegration starts, the citric acid: a) helps combining the ingredients forming a homogenous creamy and smooth paste; b) acts as an emulsifying agent to keep the tahini, water and chickpea from separating; and c) is a natural preservative but does not have a long lasting effect.

Although the hummus food product, with its individual packaging has a shelf life of 18 months, the shortest of the three ingredients, once the three ingredients are mixed, the hummus only has a consumption period equal to that of a freshly prepared hummus that is not separated or bagged. Therefore, it is recommend refrigerating the hummus after stirring and consuming within 48 hours—just as done for a fresh hummus food product.

With this process, the present invention ensures the hummus to be: preservative free; shelf stable; fresh; Smooth/creamy; and have fewer calories in comparison to other hummus food product which use additional ingredients or preservatives and stabilizers that allow the hummus to last longer—but in a refrigerator.

It will be understood by those of skill in the art that numerous and various modifications can be made without departing from the spirit of the present invention. Therefore, it should be clearly understood that the forms of the present invention are illustrative only and are not intended to limit the scope of the present invention.

As to a further discussion of the manner of usage and operation of the present invention, the same should be apparent from the above description. Accordingly, no further discussion relating to the manner of usage and operation will be provided.

It is appreciated that the relationships for the parts of the present invention, to include variations, are deemed readily apparent and obvious to one of ordinary skill in the art, and all equivalent relationships in the above description are intended to be encompassed by the present invention.

In addition, other areas of art may benefit from this method and adjustments to the design are anticipated. Thus, the scope of the present invention should be determined by the appended claims and their legal equivalents, rather than by the examples given.

The embodiments of the present invention in which an exclusive property or privilege is claimed are defined as follows:

1. A shelf stable hummus food product comprising:
chickpeas;
tahini (ground sesame seeds); and
one or more spices,
wherein each of the three ingredients are isolated from each other.

2. The food product of claim 1, wherein the hummus food product is shelf-stable, does not require refrigeration, and does not contain any artificial preservatives.

3. The food product of claim 1, wherein each of the three ingredients are provided in their own separate packages or bags.

4. The food product of claim 1, wherein each of the three ingredients are provided in their own separate compartments of a package or container.

5. The food product of claim 4, wherein the package or container can also be used as a mixing bowl.

6. The food product of claim 1, which has a shelf life of at least eighteen months.

7. A process for manufacturing a preservative-free hummus with prolonged shelf-life, comprising the steps of:
a. soaking the chickpeas overnight;
b. removing the skins of the cooked chickpeas by cooking them with baking soda;
c. mashing the chickpeas to a smooth puree;
d. filling laminated pouches with the puree;
e. subjecting the pouches to a retort process for sterilization;
f. toasting the tahini; and
g. blending a mixture of one or more spices.

8. The process of claim 7, wherein each of the three ingredients are provided in their own separate packages or bags.

9. The process of claim 7, wherein the spices are selected from a group comprising: lemon, salt, garlic, and cumin.

10. The process of claim 7, wherein when required to make the hummus, further comprising the steps of:
opening each packet;
emptying the contents completely into a container; and
stirring all ingredients together thoroughly until smooth.
